(19) United States
(12) Patent Application Publication
(10) Pub. No.: US 2023/0055301 A1
(43) Pub. Date: Feb. 23, 2023

(54) Stabilizer Composition

(71) Applicant: SI GROUP SWITZERLAND (CHAA), Pratteln (CH)

(72) Inventors: Clément Barrière, Whitefield (GB); Maurice Power, Salford, Greater Manchester (GB)

(21) Appl. No.: 17/789,022

(22) PCT Filed: Dec. 21, 2020
(86) PCT No.: PCT/EP2020/087416

§ 371 Date: Jun. 24, 2022

(30) Foreign Application Priority Data
Dec. 24, 2019 (GB) 1919296.2

(51) Int. Cl. C08K 5/134; C08K 5/52; C08J 9/00

(52) U.S. Cl. CPC C08K 5/134; C08K 5/52; C08J 9/0095; C08K 2201/019; C08K 2201/014; C08J 2375/04

(57) ABSTRACT

The invention provides a stabilising composition for a polyol and/or a polyurethane, comprising:
a) a first derivatised phenolic antioxidant having a molecular weight of at least about 400 g/mol and a melting point of less than about 100° C.;
b) a second derivatised phenolic antioxidant having lower steric hindrance than the first derivatised phenolic antioxidant, which is a solid at ambient conditions; and
c) a secondary antioxidant comprising a phosphite and/or a thioester,
   and also disclosed is a fire retardant blend comprising the stabilising composition and a fire retardant.

The present invention concerns stabilising compositions. The stabilising compositions are particularly useful for the stabilisation of polyols and polyurethanes, including polyurethane foams.

Polyurethanes constitute a class of polymers with a range of structures, properties and applications. They all have carbamate or urethane linkages i.e. —NH—C(═O)—O— and can be made by reacting isocyanates with polyols. Polyurethanes can be tailored according to the choice of isocyanate and polyol, the presence of other components, and the reaction conditions. Polyurethanes include thermoplastic materials and thermosetting materials, and are used to produce flexible and rigid foams, coatings, fibres, moulded products, elastomeric components, seals and adhesives, amongst other products.

Polyurethane foams may be manufactured by reacting an isocyanate with a polyol and water which results in simultaneous polymerisation and expansion by internally generated carbon dioxide. Both the polymerisation reaction of the isocyanate and polyol and the reaction of isocyanate with water to generate carbon dioxide, are hugely exothermic. The polyurethane foam is itself insulating, and this results in large amounts of heat being trapped within the foam which can cause or enhance degradation of the foam by a free radical autoxidation cycle. The free radicals may react with oxygen to form peroxy radicals. The peroxy radicals may then react with further polymer species to produce hydroperoxides, which themselves decompose to result in further reactive free radical species.

This type of degradation is often referred to as scorch. Scorch may be detected in a polyurethane foam by the appearance of darker regions in the foam i.e. discolouration.

Antioxidants can be used to break the polymer degradation cycle, thus reducing the amount of scorch. Some antioxidants, known as primary antioxidants, act by reacting with peroxy radicals. Other antioxidants, known as secondary antioxidants, act by reacting with hydroperoxides.

Types of primary antioxidants include sterically hindered phenols and aminic compounds, in particular secondary arylamines, for example those described in U.S. Pat. No. 4,824,601. It is known to use these two types of primary antioxidants in combination for the stabilisation of polyurethanes, for example as described in WO 2015/132087.

Stabilising compositions comprising a phenolic antioxidant and an aminic antioxidant have demonstrated effective in-process stabilisation of polyurethanes, in particular good scorch performance. However, aminic antioxidants such as alkylated diphenylamines tend to perform poorly with regards to discolouration when exposed to light and/or pollutant gases such as nitrogen oxides.

Phenolic antioxidants alone tend not to perform as well as stabilising compositions with both phenolic and aminic antioxidants, with regards to scorch reduction. Thus, alternatives to aminic antioxidants in the stabilising composition have been considered.

One alternative considered in the prior art is a stabilising composition having a phenolic antioxidant and a benzofuranone component such as those described in EP 1291384. The benzofuranone component acts as a ‘booster’ i.e. a component which improves the scorch performance of the stabilising composition beyond the base stabilisation of the phenolic component. However, such stabilising compositions tend to exhibit poorer oxidative-onset temperature (OOT) performance compared to stabilising compositions involving an aminic antioxidant.

Another alternative considered in the prior art is a stabilising composition having a phenolic antioxidant and 4-tertbutyl catechol.

U.S. Pat. No. 6,676,849 describes a scorch inhibitor composition for use as an additive in the manufacture of polyurethane foams, comprising: a derivatised di-tert-butyl phenol substituted with an aromatic, aliphatic or aromatic-aliphatic moiety of C₂ or greater, the moiety optionally possessing combinations of heteroatoms, which optionally may be dimerized; 4-tertbutyl catechol; and optionally phenothiazine.

However, such stabilising compositions tend to be highly emissive when tested according to VDA 278.

WO 2017/037204 describes a stabilising composition, comprising one or more phenolic compounds having the structure of formula (I):

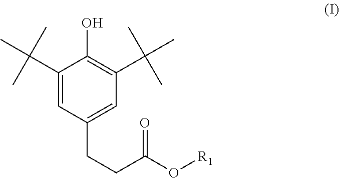

wherein R₁ is a linear or branched alkyl group having from 12 to 20 carbon atoms; and one or more second phenolic antioxidants independently selected from: a mono-hydroxybenzene having lower steric hindrance than the first phenolic antioxidant; a di-hydroxybenzene; and/or a tri-hydroxybenzene.

However, WO 2017/037204 does not contemplate the use of secondary antioxidants due to concerns relating to the hydrolytic stability of such antioxidants.

WO 2017/037205 describes the use of a stabilising composition for stabilising a polyol and/or a polyurethane, the stabilising composition comprising: a phenolic antioxidant; and one or more phosphite antioxidants having the structure of formula I:

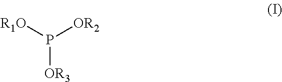

wherein R₁, R₂ and R₃ are independently selected alkylated aryl groups of the structure:

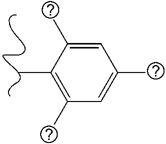

wherein R₄, R₅ and R₆ are independently selected from the group consisting of hydrogen and C₁ to C₆ alkyl, provided that at least one of R₄, R₅ and R₆ is not hydrogen. However, WO 2017/037205 teaches away from using booster components.

One industry-available stabilising composition is composed of a hindered phenolic antioxidant having the CAS number 125643-61-0, a phosphite antioxidant having the CAS number 145650-60-8 and a benzofuranone (3-(2-acetyl-5-isooctylphenyl)-5-isooctylbenzofuran-2-one) having the CAS number 216698-07-6.

However, this stabilising composition has demonstrated considerable emissions when tested according to VDA 278 particularly with regards to FOG. There is now a strong demand, particularly from the automotive industry, to significantly reduce or eliminate volatile emissions from stabilising compositions.

US2015/315465 describes stabiliser compositions which include an ortho-hydroxyl tris-aryl-s-triazine compound; a hindered amine light stabiliser compound; a hindered hydroxybenzoate compound; a phosphite compound, an acid scavenger and/or a thioester; and a hindered phenol antioxidant compound.

CN104327368 describes a self-crosslinking expansion flame retardant material.

EP1041582 describes a composition comprising: polyethylene; a substituted hydroquinone or 4,4′-thiobis(2-t-butyl-5-methyl phenol) as a first scorch inhibitor; distearyl disulfide as a second scorch inhibitor; and an organic peroxide.

EP0965998 describes a composition comprising: a low density homopolymer of ethylene prepared by a high pressure process; a scorch inhibitor selected from the group consisting of a substituted hydroquinone; 4,4′-thiobis(2-methyl-6-t-butylphenol); 2,2′-thiobis(6-t-butyl-4-methylphenol); 4,4′-thiobis(2-t-butyl-5-methyl-phenol) in an amount of about 0.02 to about 0.07 parts by weight of scorch inhibitor per 100 parts by weight of homopolymer; a cure booster; and an organic peroxide.

CN103709713 describes a light diffusion material comprising polycarbonate resin, light diffusing agent, light stabiliser, composite antioxidant and composite flame retardant.

However, the antioxidant compositions described in EP1041582, EP0965998 and CN103709713 have relatively high melting points, and are not stable liquids at temperatures below 100° C.

Thus, there remains a need for an antioxidant stabilising composition which overcomes the above-identified problems associated with the prior art stabilising compositions, and which satisfies the requirements of an antioxidant stabilising composition with regard to physical state, shelf-life, sensitivity to hydrolysis, in-process stabilisation, scorch protection, colour properties, volatility and protection against light and pollutant gases.

According to an aspect of the present invention there is provided a stabilising composition for a polyol and/or a polyurethane, comprising:
a) a first derivatised phenolic antioxidant having a molecular weight of at least about 400 g/mol and a melting point of less than about 100° C.;
b) a second derivatised phenolic antioxidant having lower steric hindrance than the first derivatised phenolic antioxidant, which is a solid at ambient conditions; and
c) a secondary antioxidant comprising a phosphite and/or a thioester.

According to another aspect of the present invention there is provided a stabilising composition for a polyol and/or a polyurethane, comprising:
a) a first derivatised phenolic antioxidant having a molecular weight of at least about 400 g/mol effective to provide a contribution to VOC of less than about 10 ppm and/or a contribution to FOG of less than about 100 ppm, and having a melting point of less than about 100° C.;
b) a second derivatised phenolic antioxidant having lower steric hindrance than the first derivatised phenolic antioxidant, which is a solid at ambient conditions; and
c) a secondary antioxidant comprising a phosphite and/or a thioester.

According to another aspect of the present invention there is provided a stabilising composition for a polyol and/or a polyurethane, comprising:
a) a first derivatised phenolic antioxidant having a contribution to VOC of less than about 10 ppm and/or a contribution to FOG of less than about 100 ppm, when determined according to standard test method VDA 278, and having a melting point of less than about 100° C.;
b) a second derivatised phenolic antioxidant having lower steric hindrance than the first derivatised phenolic antioxidant, which is a solid at ambient conditions; and
c) a secondary antioxidant comprising a phosphite and/or a thioester.

“Ambient conditions” in this context and throughout the specification means atmospheric pressure (101.325 kPa) and a temperature of 25° C.

The stabilising composition of the invention may be absent any diphenylamine and/or alkylated diphenylamine.

The stabilising composition of the invention may be absent any diarylamine and/or alkylated diarylamine.

The stabilising composition of the invention may be absent any diarylamine and/or derivative thereof.

The stabilising composition of the invention may be absent any aminic primary antioxidant.

In this context, by “absent” it is meant that the stabilising composition has none of the component present or that it comprises the component only in de minimis amounts ineffective to cause significant discolouration in the polyol and/or the polyurethane to which the stabilising composition of the invention is added, and/or ineffective to breach regulatory standards so far as the presence of residual amounts of diphenylamine is concerned.

The inventors of the present invention have surprisingly found that a stabilising composition of the invention, can be used to stabilise a polyol and/or a polyurethane, particularly a polyurethane foam.

Advantageously, the stabilising compositions of the present invention have a low contribution to volatile organic compounds (VOC) and low gaseous and condensable emissions (FOG). This may, at least in part, be due to the minimal volatile emissions (VOC and FOG) from the first derivatised phenolic antioxidant.

The contribution to VOC of the stabilising composition may be less than about 20 ppm, less than about 15 ppm, less than about 10 ppm, or less than about 5 ppm. The contribution to FOG of the stabilising composition may be less than about 200 ppm, less than about 150 ppm, less than about 100 ppm, or less than about 50 ppm.

The values for contribution to VOC and FOG are determined according to standard test method VDA 278 for a polyurethane foam. This standard test method was issued by “Verband Der Automobilindustrie” in October 2011, and is the internationally accepted, standardised test procedure for the quantitative analysis of volatile compounds

The polyurethane foam for VDA 278 may have been formed by a process with or using the following precursors and/or parameters:
i. a polyol having a molecular weight of about 3500 g/mol, for example CARPOL™ GP 3510;
ii. 2.5 php water for a target polyurethane foam density of 35-40 kg/m³;
iii. an isocyanate index of 105.

The polyurethane foam may have been formed by a process as outlined in the examples under heading ‘Preparation of High Density (40 kg/m³) Polyurethane Foams’.

As mentioned above, there is now a strong demand, particularly from the automotive industry, to significantly reduce or eliminate volatile emissions from stabilising compositions. It has been found that stabilising compositions of the present invention are compliant with the automotive standard test method VDA 278 for volatile emissions (VOC and FOG).

In addition, the stabilising compositions of the present invention have a high level of scorch protection. Without wishing to be bound by any such theory, it is believed that the presence of the second derivatised phenolic antioxidant increases the activity of the stabilising composition with regards to scorch protection. This component is believed to have a higher activity with regards to scorch protection than the more sterically hindered first derivatised phenolic antioxidant. Thus, when the second derivatised phenolic antioxidant is added to the first derivatised phenolic antioxidant, the activity of the stabilising composition with regards to scorch protection, is increased.

The presence of the secondary antioxidant provides good long-term stability to the stabilising composition and helps to reduce discolouration, particularly discolouration caused by the second derivatised phenolic antioxidant.

It has unexpectedly been found that the above advantages, in particular the high level of anti-scorch performance, can be realised without the use of aminic primary antioxidants such as diphenylamines and alkylated diphenylamines. This is beneficial since these types of antioxidant tend to perform poorly with regards to discolouration when exposed to light and/or pollutant gases such as nitrogen oxides.

The overall stabilising composition preferably has a melting point of less than about 100° C. The overall stabilising composition may have a melting point of less than about 90° C., less than about 80° C., less than about 70° C., less than about 60° C., or less than about 50° C. The relatively low melting point may provide the advantage of the stabilising composition being mixed with a polyol and/or a polyurethane, particularly a polyurethane foam, without heating to high temperatures.

In some instances, it may be preferable for the overall stabilising composition to be a liquid at ambient conditions i.e. at atmospheric pressure (101.325 kPa) and a temperature of 25° C. A liquid stabilising composition may be easily dispersed within a polyol and/or a polyurethane, and some polyol/polyurethane manufacturers require stabilising compositions which are liquid at ambient conditions.

The essential elements of the invention will now be particularised. These apply, where appropriate, to any aspect of the invention.

Compounds designated by the tradenames ISONOX™, NAUGARD™, ANOX™, LOWINOX™ and WESTON™ are available from SI Group USA (USAA), LLC, 4 Mountainview Terrace, Suite 200, Danbury, Conn. 06810.

### First Derivatised Phenolic Antioxidant

Advantageously, the first derivatised phenolic antioxidant has a low contribution to VOC and FOG. The first derivatised phenolic antioxidant may have a lower contribution to VOC and FOG than other known phenolic antioxidants, for example 2,6-di-tert-butyl-4-sec-butylphenol (ISONOX™ 132-CAS 17540-75-9), 2,6-di-tert-butyl-4-nonylphenol (ISONOX™ 232-CAS 4306-88-1), and benzenepropanoic acid, 3,5-bis(1,1-dimethyl-ethyl)-4-hydroxy-, C7-C9 branched alkyl esters (NAUGARD™ PS48-CAS 125643-61-0).

The contribution to VOC of the first derivatised phenolic antioxidant may be less than about 10 ppm, less than about 5 ppm, less than about 2 ppm, or less than about 1 ppm. The contribution to FOG of the first derivatised phenolic antioxidant may be less than about 100 ppm, less than about 50 ppm, less than about 20 ppm, or less than about 10 ppm.

The values for contribution to VOC and FOG are determined according to standard test method VDA 278 for a polyurethane foam.

The first derivatised phenolic antioxidant has a molecular weight of at least about 400 g/mol. The first derivatised phenolic antioxidant may have a molecular weight of at least about 410 g/mol, at least about 420 g/mol, at least about 430 g/mol, at least about 440 g/mol, at least about 450 g/mol, at least about 460 g/mol, at least about 470 g/mol, or at least about 480 g/mol.

The relatively high molecular weight of the first derivatised phenolic antioxidant may explain, at least in part, the low contribution to VOC and FOG of this component.

The first derivatised phenolic antioxidant may comprise a single derivatised phenolic antioxidant or a blend of two or more derivatised phenolic antioxidants.

The first derivatised phenolic antioxidant may comprise one or more derivatised phenolic antioxidants of formula (I):

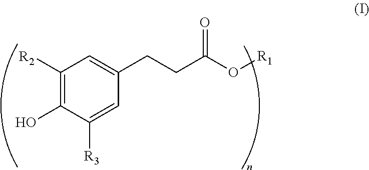

wherein n is 1 or 2;
wherein R₁ is a linear or branched alkyl group having from 1 to 30 carbons, optionally substituted with one or more ether groups; and
wherein R₂ and R₃ are each independently selected from straight or branched chain alkyl groups having from 1 to 5 carbon atoms.

R₂ and R₃ may be selected from methyl, ethyl, propyl, n-butyl, t-butyl and t-amyl.

Preferably, R₂ and R₃ comprise the same substituent group. More preferably, both R₂ and R₃ are t-butyl groups.

By way of specific and non-limiting example, the first derivatised phenolic antioxidant may comprise one or more of 3,5-bis(1,1-dimethylethyl)-4-hydroxy-benzenepropanoic acid, C13-15 alkyl esters (ANOX™ 1315-CAS 171090-93-0); benzenepropanoic acid, 3,5-bis(1,1-dimethylethyl)-4-hydroxy-, isotridecyl ester (CAS 847488-62-4); a bisphenolic stabiliser of formula (II) wherein n is 1, 2, 3, 4, 5, 6, 7, 8, 9, 10 or 11 (as disclosed in WO2017125291); octadecyl-3-(3′,5′-di-t-butyl-4′-hydroxyphenyl) propionate (ANOX™ PP18-CAS 2082-79-3); 2,2′thiodiethylene bis[3(3,5-di-t-butyl-4-hydroxyphenyl)propionate] (ANOX™ 70-CAS 41484-35-9); n-hexadecyl-3,5-di-tert-butyl-4-hydroxybenzoate (CAS 67845-93-6); and/or mixtures of two or more thereof.

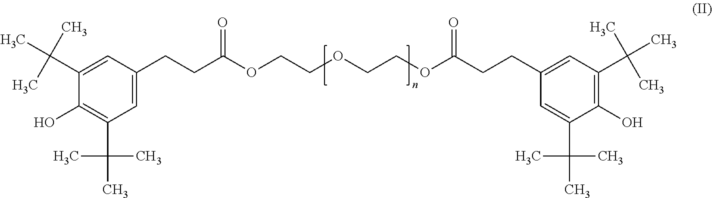

The first derivatised phenolic antioxidant has a melting point of less than about 100° C. The first derivatised phenolic antioxidant may have a melting point of less than about 90° C., less than about 80° C., less than about 70° C., less than about 60° C., or less than about 50° C.

In this context and throughout the specification, the term “melting point” covers both a precise melting point and a melting range. Where the first derivatised phenolic antioxidant (or other component) has a melting range, the entire melting range must fall within the defined temperature range.

In some instances, it may be preferable for the first derivatised phenolic antioxidant to be a liquid at ambient conditions i.e. at atmospheric pressure (101.325 kPa) and a temperature of 25° C.

Where the first derivatised phenolic antioxidant is a liquid at ambient conditions, it may be capable of dissolving the second derivatised phenolic antioxidant and/or the secondary antioxidant to form an overall liquid stabilising composition at ambient conditions. As previously mentioned, a liquid stabilising composition may be more easily dispersed within a polyol and/or a polyurethane.

As outlined above, the first derivatised phenolic antioxidant may not necessarily comprise a single derivatised phenolic antioxidant but may comprise a blend of two or more derivatised phenolic antioxidants. The two or more derivatised phenolic antioxidants may be selected to provide complementary properties, for example in terms of melting point and low emissivity.

In this instance, it may be possible to include in the blend one or more derivatised phenolic antioxidants which do not have a melting point of less than about 100° C. but which nevertheless may be blended with one or more other compatible derivatised phenolic antioxidants to yield a blend which has a melting point of less than about 100° C.

Specific, non-limiting examples of such derivatised phenolic antioxidants include tetrakismethylene (3,5-di-t-butyl-4-hydroxyhydrocinnamate) methane (ANOX™ 20-CAS 6683-19-8); 1,3,5-tris(3,5-di-t-butyl-4-hydroxybenzyl) isocyanurate (ANOX™ IC14-CAS 27676-62-6); N,N′-hexamethylene bis[3-(3,5-di-t-butyl-4-hydroxyphenyl)propionamide] (LOWINOX™ HD98-CAS 23128-74-7); 1,2-bis(3,5-di-t-butyl-4-hydroxyhydrocinnamoyl)hydrazine (LOWINOX™ MD24-CAS 32687-78-8); the butylated reaction product of p-cresol and dicyclopentadiene (LOWINOX™ CPL-CAS 68610-51-5); 2,2′-ethylidenebis[4,6-di-t-butylphenol] (ANOX™ 29-CAS 35958-30-6); 1,3,5-trimethyl-2,4,6-tris(3,5-di-t-butyl-4-hydroxybenzyl)benzene (ANOX™ 330-CAS 1709-70-2); triethyleneglycol-bis-[3-(3-t-butyl-4-hydroxy-5-methylphenyl)propionate] (LOWINOX™ GP45-CAS 36443-68-2); 2,2′-oxamidobis[ethyl-3-(3,5-di-t-butyl-4-hydroxyphenyl)propionate] (NAUGARD™ XL-1-CAS 70331-94-1); and/or mixtures of two or more thereof.

As a particular example, the first derivatised phenolic antioxidant may comprise a blend of ANOX™ 1315 and ANOX™ 20. In this instance, ANOX™ 20 (a solid having a melting range of 110-125° C.) is dissolved within ANOX™ 1315 to form a blend which has a melting point of less than 100° C.

As a further example, the first derivatised phenolic antioxidant may comprise a blend of ANOX™ PP18 and ANOX™ 20. Again, this blend has a melting point of less than 100° C.

Particularly preferred first derivatised phenolic antioxidants comprise 3,5-bis(1,1-dimethylethyl)-4-hydroxy-benzenepropanoic acid, C13-15 alkyl esters (ANOX™ 1315); a blend of 3,5-bis(1,1-dimethylethyl)-4-hydroxy-benzenepropanoic acid, C13-15 alkyl esters (ANOX™ 1315) and tetrakismethylene (3,5-di-t-butyl-4-hydroxyhydrocinnamate) methane (ANOX™ 20); octadecyl-3-(3′,5′-di-t-butyl-4′-hydroxyphenyl) propionate (ANOX™ PP18); and/or a blend of octadecyl-3-(3′,5′-di-t-butyl-4′-hydroxyphenyl) propionate (ANOX™ PP18) and tetrakismethylene (3,5-di-t-butyl-4-hydroxyhydrocinnamate) methane (ANOX™ 20).

The stabilising composition is preferably substantially free from reagent phenolic compound(s) i.e. phenolic compounds used in the manufacture of the first derivatised phenolic antioxidant. In particular, the stabilising composition is preferably substantially free from methyl 3-(3,5-di-tert-butyl-4-hydroxyphenyl)propionate (CAS 6386-38-5).

In this context, by “substantially free” it is meant that the reagent phenolic compound is present, if at all, in an amount of less than 0.2% by weight of the first derivatised phenolic antioxidant.

By limiting the amount of reagent phenolic compound(s) in the stabilising composition, the contribution to VOC and/or FOG is minimised.

The first derivatised phenolic antioxidant may be present in the stabilising composition in an amount of from about 30 wt. % to about 95 wt. %, from about 40 wt. % to about 95 wt. %, from about 50 wt. % to about 95 wt. %, or from about 60 wt. % to about 90 wt. %, based on the total weight of the stabilising composition.

### Second Derivatised Phenolic Antioxidant

The second derivatised phenolic antioxidant has a lower steric hindrance than the first derivatised phenolic antioxidant. What is meant by this is that either the number of substituent groups ortho to the phenolic moiety in the second derivatised phenolic antioxidant is lower than the number of substituent groups ortho to the or a phenolic moiety in the first derivatised phenolic moiety; or that the size of any substituent group ortho to the or a phenolic moiety in the second derivatised phenolic antioxidant is smaller than the size of any substituent group ortho to the or a phenolic moiety in the first derivatised phenolic moiety, or both.

The second derivatised phenolic antioxidant preferably has a lower molecular weight than the first derivatised phenolic antioxidant. Where this is the case and the first derivatised phenolic antioxidant comprises two or more components, the second derivatised phenolic antioxidant has a lower molecular weight than each of the components. Where the second derivatised phenolic antioxidant comprises two or more components, each of these has a lower molecular weight than the (or each) first derivatised phenolic antioxidant component.

The second derivatised phenolic antioxidant may have a molecular weight lower than about 600 g/mol. The second derivatised phenolic antioxidant may have a molecular weight of about 550 g/mol or lower, about 500 g/mol or lower, about 480 g/mol or lower, about 470 g/mol or lower, about 460 g/mol or lower, about 450 g/mol or lower, about 440 g/mol or lower, about 430 g/mol or lower, about 420 g/mol or lower, about 410 g/mol or lower, or lower than about 400 g/mol. In some instances, the second derivatised phenolic antioxidant may have a molecular weight of about 390 g/mol or lower, about 380 g/mol or lower, about 370 g/mol or lower, or about 360 g/mol or lower.

The second derivatised phenolic antioxidant is believed to increase the activity of the stabilising composition, in particular with regards to scorch protection. Thus, the second derivatised phenolic antioxidant may be referred to as a ‘booster’ antioxidant. Without wishing to be bound by any such theory, it is believed that the second derivatised phenolic antioxidant is more reactive than the first derivatised phenolic antioxidant due to the lower steric hindrance around the phenolic moiety and an overall smaller molecule size.

The second derivatised phenolic antioxidant may comprise a single derivatised phenolic antioxidant or a combination of two or more derivatised phenolic antioxidants.

The second derivatised phenolic antioxidant may comprise a mono-hydroxybenzene and/or a di-hydroxybenzene.

The mono-hydroxybenzene may comprise a bridged bisphenol, for example a sulphur-bridged bisphenol or a CR₂-bridged bisphenol. Sulphur-bridged bisphenols may include 4,4′-thiobis(2-t-butyl-5-methylphenol) (LOWINOX™ TBM-6-CAS 96-69-5); and/or 2,2′-thiobis(6-t-butyl-4-methylphenol) (LOWINOX™ TBP-6-CAS 90-66-4).

The di-hydroxybenzene may comprise 4-tert-butylcatechol (4-TBC); and 2,5-di-tert-amyl-hydroquinone (LOWINOX™ AH25-CAS 79-74-3).

The second derivatised phenolic antioxidant preferably comprises 4-tert-butylcatechol (4-TBC); 2,5-di-tert-amyl-hydroquinone (LOWINOX™ AH25-CAS 79-74-3); 4,4′-thiobis(2-t-butyl-5-methylphenol) (LOWINOX™ TBM-6-CAS 96-69-5); 2,2′-thiobis(6-t-butyl-4-methylphenol) (LOWINOX™ TBP-6-CAS 90-66-4); and/or combinations of two or more thereof.

A particularly preferred second derivatised phenolic antioxidant comprises 4-TBC.

Another particularly preferred second derivatised phenolic antioxidant comprises a combination of LOWINOX™ AH25 with LOWINOX™ TBM-6 and/or LOWINOX™ TBP-6.

The combination of LOWINOX™ AH25 with LOWINOX™ TBM-6 and/or LOWINOX™ TBP-6 and a phosphite secondary antioxidant, has been found to be particularly beneficial with regards to scorch protection and has surprisingly good colour stability.

The second derivatised phenolic antioxidant is a solid at ambient conditions i.e. at atmospheric pressure (101.325 kPa) and a temperature of 25° C.

The second derivatised phenolic antioxidant may be present in the stabilising composition in an amount of from about 0.1 wt. %, about 0.5 wt. %, about 1 wt. %, or about 5 wt. %; to about 50 wt. %, about 45 wt. %, about 40 wt. %, about 35 wt. %, about 30 wt. %, about 25 wt. %, or about 20 wt. %, based on the total weight of the stabilising composition.

For example, the second derivatised phenolic antioxidant may be present in the stabilising composition in an amount of from about 0.1 wt. % to about 50 wt. %, from about 0.5 wt. % to about 45 wt. %, from about 1 wt. % to about 40 wt. %, from about 5 wt. % to about 35 wt. %, from about 1 wt. % to about 20 wt. %, or from about 5 wt. % to about 20 wt. %, based on the total weight of the stabilising composition.

### Secondary Antioxidant

The presence of the secondary antioxidant has been found to improve the colour stability of the stabilising composition. In particular, the presence of the secondary antioxidant has been found to significantly reduce discolouration caused by the second derivatised phenolic antioxidant.

As an example, LOWINOX™ AH25 is a good scorch inhibitor but known to cause discolouration. The inventors of the present invention have surprisingly found that when LOWINOX™ AH25 is used in combination with the secondary antioxidant, particularly a phosphite, discolouration is significantly reduced. A synergistic effect involving a further reduction in discolouration is observed when LOWINOX™ AH25 is used in combination with LOWINOX™ TBM-6 and/or LOWINOX™ TBP-6, and a phosphite secondary antioxidant.

The secondary antioxidant comprises a phosphite and/or a thioester.

Preferably, the phosphite comprises one or more alkyl phosphites, optionally one or more trialkyl phosphites.

By way of specific and non-limiting example, the alkyl phosphite may comprise one or more of trilauryl phosphite (WESTON™ TLP-CAS 3076-63-9); triisodecyl phosphite (WESTON™ TDP-CAS 25448-25-3); triisodecyl phosphite, phenol-free (WESTON™ TDP ZP-CAS 25448-25-3); tris(dipropyleneglycol) phosphite (WESTON™ 430-CAS 36788-39-3); tris(dipropyleneglycol) phosphite, phenol-free (WESTON™ 430 ZP-CAS 36788-39-3); distearyl pentaerythritol diphosphite (WESTON™ 618-CAS 3806-34-6); distearyl pentaerythritol diphosphite, flake (WESTON™ 618F-CAS 3806-34-6); and/or mixtures of two or more thereof.

Additionally or alternatively the phosphite may comprise one or more alkyl-aryl phosphites and/or triaryl phosphites.

By way of specific and non-limiting example, the alkyl-aryl phosphite may comprise butane-1,1-diylbis(2-(tert-butyl)-5-methyl-4,1-phenylene) tetratridecyl bis(phosphite) (CAS 13003-12-8).

By way of specific and non-limiting example, the triaryl phosphite may comprise WESTON™ 705-CAS 939402-02-5.

Preferably the phosphite is substantially free from phenol.

In this context, by “substantially free” it is meant that the phenol is present, if at all, in an amount of about 1% or less by weight of the phosphite.

Certain phosphites are manufactured from reactants, such as triphenyl phosphite, which result in a phenol by-product being formed. However, the presence of a phenol by-product in the phosphite is undesirable as there are health and safety risks associated with phenol. Thus, a phosphite which is substantially free from phenol offers advantages in terms of safety.

The phosphite may have a melting point of less than about 100° C., less than about 90° C., less than about 80° C., less than about 70° C., less than about 60° C., or less than about 50° C. The phosphite may be a liquid at ambient conditions i.e. at atmospheric pressure (101.325 kPa) and a temperature of 25° C.

In this context by “thioester” it is meant a compound comprising both a thio group and an ester group.

By way of specific and non-limiting example, the thioester may comprise one or more of di(tridecyl) thiodipropionate (NAUGARD™ DTDTDP-CAS 10595-72-9); distearyl thiodipropionate (NAUGARD™ DSTDP-CAS 693-36-7); dilauryl thiodipropionate (NAUGARD™ DLTDP-CAS 123-28-4); and/or mixtures of two or more thereof.

The secondary antioxidant may have a melting point of less than about 100° C., less than about 90° C., less than about 80° C., less than about 70° C., less than about 60° C., or less than about 50° C.

The secondary antioxidant may be present in the stabilising composition in an amount of from about 0.01 wt. % to about 20 wt. %, from about 0.05 wt. % to about 15 wt. %, or from about 0.1 wt. % to about 10 wt. %, based on the total weight of the stabilising composition.

### Fire Retardant Blends

The stabilising composition of the present invention may be combined with a fire retardant to form a fire retardant blend.

Thus, according to another aspect of the present invention there is provided a fire retardant blend comprising:
i. the stabilising composition as previously defined according to any aspect of the invention; and
ii. a fire retardant.

The fire retardant may comprise a halogenated fire retardant or a non-halogenated fire retardant.

Examples of halogenated fire retardants include organohalogen compounds, for example organochlorines such as chlorendic acid derivatives and chlorinated paraffins; organobromines such as decabromodiphenyl ether and decabromodiphenyl ethane; and chlorinated organophosphates such as tris(1,3-dichloro-2-propyl) phosphate, and oxydi-2,1-ethanediyl-phosphoric acid tetrakis(2-chloro-1-methylethyl) ester.

Examples of non-halogenated fire retardants include organophosphorus compounds, for example organophosphates such as t-butylphenyl diphenyl phosphate, triphenyl phosphate (TPP), resorcinol bis(diphenylphosphate) (RDP), bisphenol A diphenyl phosphate (BADP), and tricresyl phosphate (TCP); phosphonates such as dimethyl methylphosphonate (DMMP); and phosphinates such as aluminium diethyl phosphinate.

Certain prior art stabilising compositions are known to cause discolouration in fire retardants when exposed to light and on heat ageing. Conversely, the inventors of the present invention have found that when the stabilising composition of the present invention is combined with a fire retardant, it imparts very little discolouration when exposed to light and on heat ageing. This is advantageous as it allows the stabilising composition to be pre-mixed with a fire retardant prior to use in a polyol/polyurethane.

The stabilising composition may be present in the fire retardant blend in an amount of from about 0.1% to about 20%, from about 0.5% to about 15%, or from about 1% to about 10% by weight of the fire retardant.

The stabilising composition or fire retardant blend of the present invention may be effective at stabilising polyols and/or polyurethanes, particularly polyurethane foams. The polyol and/or polyurethane may be stabilised against oxidative, thermal and/or radiation (for example light e.g. UV light) induced degradation.

Thus, according to another aspect of the present invention there is provided the use of the stabilising composition or fire retardant blend as hereinbefore described to stabilise a polyol and/or a polyurethane.

According to another aspect of the present invention there is provided a stabilised composition, comprising:
a polyol and/or a polyurethane; and
the stabilising composition or fire retardant blend as hereinbefore described.

The polyol may, for example, comprise a polyether polyol and/or a polyester polyol. The polyol may be a precursor for a polyurethane.

The polyurethane may be a polyurethane foam.

The stabilising composition and fire retardant blend of the present invention have been found to be particularly effective at stabilising low, medium and high density polyurethane foams, having a density of greater than 15 kg/m³.

The stabilising composition may be present in the stabilised composition in an amount of from about 0.01% to about 10%, from about 0.01% to about 5%, from about 0.01% to about 3.5% or from about 0.01% to about 2% by weight of the polyol and/or polyurethane.

The fire retardant blend may be present in the stabilised composition in an amount of from about 1% to about 30%, from about 5% to about 25%, or from about 10% to about 20% by weight of the polyol and/or polyurethane.

The present invention also provides a stabilising composition which when incorporated into a polyurethane foam causes the foam to undergo, on the application of a microwave scorch test, a colour change ΔE less than that of an equivalent foam into which an equivalent amount of industry-available stabilising composition has been incorporated, such as industry-available stabilizing composition 1, 2, 3, or 4 identified in the Examples below. The stabilising composition of the invention is advantageously selected from a stabilising composition in accordance with any aspect of the foregoing description, and details of a suitable microwave scorch test are provided in the examples below.

The present invention also provides a stabilising composition which when incorporated into a polyurethane foam exhibits a contribution to VOC and/or FOG, as measured according to standard test method VDA 278, less than the contribution exhibited by an equivalent foam into which an equivalent amount of industry-available stabilising composition has been incorporated, such as industry-available stabilising compositions 1, 2, 3, or 4 identified in the Examples below. The stabilising composition of the invention is advantageously selected from a stabilising composition in accordance with any aspect of the foregoing description.

The invention will now be more particularly described with reference to the following, non-limiting examples, in which the First Derivatised Phenolic Antioxidant as discussed above is designated as component type a), the Second Derivatised Phenolic Antioxidant as discussed above is designated as component type b), and the Secondary Antioxidant as discussed above is designated as component type c).

### EXAMPLES

The individual components of the stabilising compositions investigated herein are outlined in Table 1 below. Hereinafter, the individual components will be referred to using the name given in the ‘component’ column.

TABLE 1

| | Com- ponent | | |
|---|---|---|---|
| Component | Type | CAS No. | Description |
| ANOX ™ 1315 | (a) | 171090- 93-0 | 3,5-bis(1,1-dimethylethyl)- 4-hydroxy-benzenepropanoic |
| | | | acid, C13-15 alkyl esters |
| ANOX ™ PP18 | (a) | 2082-79-3 | octadecyl-3-(3′,5′-di-t-butyl-4′- |
| | | | hydroxyphenyl) propionate |
| ANOX ™ 20 | (a) | 6683-19-8 | Tetrakismethylene (3,5-di-t- butyl-4-hydroxyhydrocinnamate) |
| | | | methane |
| 4-TBC | (b) | 98-29-3 | 4-tertbutyl catechol |
| LOWINOX ™ AH25 | (b) | 79-74-3 | 2,5-di-tert-amyl-hydroquinone |
| LOWINOX ™ | (b) | 90-66-4 | 2,2′-thiobis(6-t-butyl- |
| TBP-6 | | | 4-methylphenol) |
| LOWINOX ™ | (b) | 96-69-5 | 4,4′-thiobis(2-t-butyl- |
| TBM-6 | | | 5-methylphenol) |
| WESTON ™ TLP | (c) | 3076-63-9 | Trilauryl phosphite |
| WESTON ™ TDP | (c) | 25448-25-3 | Triisodecyl phosphite |
| ZP | | | |
| WESTON ™ 430 ZP | (c) | 36788-39-3 | Tris(dipropyleneglycol) phosphite |
| WESTON ™ 618 | (c) | 3806-34-6 | Distearyl pentaerythritol diphosphite |
| NAUGARD ™ | (c) | 10595-72-9 | Di(tridecyl) thiodipropionate |
| DTDTDP | | | |

Stabilising compositions were prepared by mixing the relative amounts of the components identified in Table 2.

TABLE 2

| | Amount (wt. %) | | | | | |
|---|---|---|---|---|---|---|
| | ANOX ™ | ANOX ™ | ANOX ™ | 4- | LOWINOX ™ | LOWINOX ™ |
| Example | 1315 | PP18 | 20 | TBC | AH25 | TBP-6 |
| 1 | 79 | — | 10 | 10 | — | — |
| 2 | 79 | — | 10 | 10 | — | — |
| 3 | 85 | — | — | — | 5 | 5 |
| 4 | 85 | — | — | — | 5 | 5 |
| 5 | 85 | — | — | — | 5 | — |
| 6 | 79.5 | — | 10 | 10 | — | — |
| 7 | — | 74 | 15 | 10 | — | — |

| | Amount (wt. %) | | | |
|---|---|---|---|---|
| | WESTON ™ | WESTON ™ | WESTON ™ | NAUGARD ™ |
| Example | TLP | TDP ZP | 618 | DTDTDP |
| 1 | 1 | — | — | — |
| 2 | — | 1 | — | — |
| 3 | 5 | — | — | — |
| 4 | — | 5 | — | — |
| 5 | 5 | — | — | 5 |
| 6 | 0.5 | — | — | — |
| 7 | — | — | 1 | — |

In addition to the stabilising compositions in Table 2, the industry-available stabilising compositions identified in Table 3 were also tested.

TABLE 3

| Exam- | | | Component Types |
|---|---|---|---|
| ple | Designation | Description | Present |
| A | Industry- | Phenolic antioxidant | Only (a) |
| (Comp) | available | according to component type | |
| | Stabilising | (a) + lactone (CAS | |
| | Composition 1 | 1261240-30-5) | |
| B | Industry- | Bisphenolic antioxidant | (a) + (b), |
| (Comp) | available | stabiliser of formula (II) | not (c) |
| | Stabilising | described above + vitamin E | |
| | Composition 2 | (CAS 59-02-9) | |
| C | Industry- | 7:1:1 blend hindered | Only (c) |
| (Comp) | available | phenolic (CAS 125643-61-0): | ((b) is not |
| | Stabilising | phosphite (CAS 145650-60- | present |
| | Composition 3 | 8): 3-(2-acetyl-5-isooctylphenyl)- | and the |
| | | 5-isooctylbenzofuran-2-one | phenolic |
| | | (CAS 216698-07-6) | antioxidant |
| | | | has Mw <400) |
| D | Industry- | 2:1 blend phenolic antioxidant | None |
| (Comp) | available | (CAS 125643-61-0) + | (the |
| | Stabilising | aminic antioxidant (CAS | phenolic |
| | Composition 4 | 68411-46-1) | antioxidant |
| | | | has Mw <400) |

Preparation of Medium Density (20-25 kg/m³) Polyurethane Foams

For the stabilising compositions of examples 1 to 5 and 7 outlined in Table 2 and examples A to D outlined in Table 3, 0.45 g of the stabilising composition was charged to 100 g of a 3500 Mw polyol in a 1 litre flask. The mixture was homogenised by agitation at 1900 rpm for 1 minute. To this mixture, 1.1 g of TEGOSTAB™ B8229 (Evonik), 0.27 g of a mixture of amine catalysts (3:1 DABCO™ 33LV:DABCO™ BL11), and 5 g of deionised water were added and the reaction mixture agitated for 30 seconds. 0.25 g of tin(II) ethylhexanoate (Aldrich) was immediately added and the reaction mixture agitated for a further 15 seconds. 62.7 g of toluene di-isocyanate was added to the flask and mixed for 10 seconds. The resulting mixture was quickly poured into an 18 cm×16 cm×16 cm wooden box lined with a Kraft paper mould and the internal temperature was monitored during foaming.

### Microwave Scorch Test

A BP210/50 research microwave (Microwave Research and Applications Inc.) was used for the scorch test. Once the foam had reached its maximum internal temperature, it was immediately removed from the wooden box and placed inside the microwave cavity. The microwave was set to operate at 20% maximum power (approximately 1300 W) for the desired period of time. After microwave irradiation, the foam was removed from the cavity and cured in a convection oven for 30 minutes at 95° C. When cooled, the foam was cut open and the colour of the maximum scorched area measured using an X-RITE™ ColorEye 7000A colourimeter.

The results of the microwave scorch test are presented in Table 4 below. The results are normalised relative to that of comparative example D and presented as ΔE Ex/ΔE D in accordance with the teaching of US 2011/0230579, where ΔE is the change in colour.

TABLE 4

| Example | ΔE Ex/ΔE D |
|---|---|
| 1 | 0.66 |
| 2 | 0.75 |
| 3 | 0.69 |
| 4 | 0.30 |
| 5 | 0.66 |
| 7 | 1.02 |
| A | 1.5 |
| B | 2.2 |
| C | 1.5 |
| D | 1 |

From the results it can be seen that examples 1 to 5, and 7 in accordance with the present invention all outperform the comparative examples in terms of scorch reduction.

### Gas Fading Test

For the stabilising compositions of examples 1, 3, 4, 5 and 7 outlined in Table 2 and examples A and D outlined in Table 3, foams were prepared as outlined under section ‘Preparation of Medium Density (20-25 kg/m³) Polyurethane Foams’. The foams were cured at 95° C. for 30 minutes and then cooled to room temperature. The foams were cut to prepare samples having the dimensions 100 mm×100 mm×25 mm.

Samples were tested to determine their resistance to discolouration when in contact with nitrous oxide. The test was performed according to standard test method AATCC 164—the colour was recorded after 0, 30 and 60 minutes in the oven. The colour was measured using an X-RITE™ Color i7 colourimeter. The results of the gas fading test are shown in Table 5 below.

TABLE 5

| Time | ΔE | | | a* | | | b* | | |
|---|---|---|---|---|---|---|---|---|---|
| (min) | 0 | 30 | 60 | 0 | 30 | 60 | 0 | 30 | 60 |
| A | 0.0 | 3.0 | 8.4 | 0.8 | 0.4 | 0.0 | −0.2 | 2.7 | 8.0 |
| D | 0.0 | 6.4 | 12.4 | 0.8 | 0.2 | −1.2 | −0.2 | 5.9 | 12.0 |
| 1 | 0.0 | 3.5 | 5.2 | 0.8 | 0.6 | 0.6 | −0.4 | 3.1 | 4.8 |
| 3 | 0.0 | 2.7 | 6.8 | 0.8 | 0.8 | 0.8 | −0.1 | 2.5 | 6.6 |
| 4 | 0.0 | 2.6 | 5.9 | 0.8 | 1.1 | 1.3 | −0.8 | 1.4 | 3.7 |
| 5 | 0.0 | 2.4 | 3.8 | 0.9 | 0.9 | 1.2 | −0.1 | 2.0 | 3.5 |
| 7 | 0.0 | 4.8 | 5.7 | 0.8 | 0.4 | 0.8 | 0.1 | 4.0 | 5.1 |

From the results it can be seen that the examples in accordance with the present invention all perform at least as well as the industry-available stabilising compositions of examples A and D in terms of overall colour change (ΔE) and also in terms of individual colours i.e. the a* value (representing the colour value on the scale going from green to red) and the b* value (representing the colour value on the scale going from blue to yellow). Examples 1, 3, 4, 5 and 7 perform better than the industry-available stabilising compositions.

Preparation of High Density (40 kg/m³) Polyurethane Foams

For the stabilising compositions of examples 1 to 5 outlined in Table 2 and examples A to D outlined in Table 3, 0.9 g of the stabilising composition was charged to 200 g of polyol in a 1 litre flask. The mixture was homogenised by agitation at 1900 rpm for 1 minute. To this mixture, 1.2 g of TEGOSTAB™ B8229 (Evonik), 0.60 g of a mixture of amine catalysts (3:1 DABCO™ 33LV:DABCO™ BL11), and 5 g of deionised water were added and the reaction mixture agitated for 30 seconds. 0.45 g of tin(II) ethylhexanoate (Aldrich) was immediately added and the reaction mixture agitated for a further 15 seconds. 72.2 php of toluene di-isocyanate was added to the flask and mixed for 10 seconds. The resulting mixture was quickly poured into an 18 cm×16 cm×16 cm wooden box lined with a Kraft paper mould and the internal temperature was monitored during foaming.

The resulting foam was cured at 95° C. for 30 minutes and then cooled to room temperature. The foam was cut to prepare a sample having the dimensions 100 mm×100 mm×25 mm.

### Emissions Testing According to Standard Test Method VDA 278

The foam samples were tested to determine emissions in accordance with standard test method VDA 278, issued by “Verband Der Automobilindustrie” in October 2011, the internationally accepted, standardised test procedure for the quantitative analysis of volatile compounds. The results are shown in Table 6 below.

TABLE 6

| | Emissions (ppm)* | | | | | | | | |
|---|---|---|---|---|---|---|---|---|---|
| Example | A | B | C | D | 1 | 2 | 3 | 4 | 5 |
| VOC | 1 | 5 | 23 | 50 | 0 | 0 | 0 | 0 | 0 |
| FOG | 60 | 10 | 237 | 900 | 2 | 4 | 4 | 4 | 3 |

*only the emissions attributable to the stabilising compositions are quoted

From the results it can be seen that examples 1 to 5 in accordance with the present invention outperform industry-available stabilising compositions of examples A to D. The stabilising compositions in accordance with the present invention have negligible contribution to VOC, and a significantly lower contribution to FOG emissions compared to industry—available stabilising compositions, particularly examples C and D.

### Colour Stability in Non-Halogenated Fire Retardants

The colour stability of the stabilising compositions of examples 1, 2, and 6 was tested in a fire retardant and compared to the colour stability of industry-available stabilising composition represented by example D.

A sample of the fire retardant tris(1,3-dichloro-2-propyl) phosphate (TDCPP-CAS 13674-87-8) was loaded with 3% by weight of the stabilising composition. The resulting blend was divided into two separate samples. One sample was kept at room temperature for 10 days, whilst the other was kept at 60° C. in an oven for 10 days. Following this, the APHA colour value was measured using a LOVIBOND™ PFXi-195 colourimeter.

The results are shown in Table 7 below.

TABLE 7

| | | APHA Colour | | | |
|---|---|---|---|---|---|
| Example | | 1 | 2 | 6 | D |
| Trialkyl phosphite loading (%) | | 1 | 1 | 0.5 | N/A |
| Day 0 | | 48 | 25 | 59 | 99 |
| Day 10 | RT, light | 45 | 38 | 50 | 160 |
| | 60° C. | 60 | 56 | 69 | >500 |
| | | | | | (GV: 2.6) |

From the results it can be seen that the stabilising compositions of examples 1, 2, and 6 perform significantly better with regards to colour stability in the fire retardant compared to industry-available stabilising composition of example D (amine-based).

Colour Stability of Stabilising Compositions with LOWINOX™ AH25

Stabilising compositions all involving LOWINOX™ AH25 were prepared by mixing the relative amounts of the components identified in Table 8.

TABLE 8

| | Amount (wt. %) | | | |
|---|---|---|---|---|
| | LOWINOX ™ | WESTON ™ | LOWINOX ™ | ANOX ™ |
| Example | AH25 | 430 ZP | TBM-6 | 1315 |
| 8 (Comp) | 5 | — | — | 95 |
| 9 | 5 | 10 | — | 85 |
| 10 | 5 | 10 | 10 | 75 |
| 11 (Comp) | 5 | — | 10 | 85 |

Discolouration of each of the stabilising compositions was investigated.

A sample of each of the stabilising compositions was prepared under nitrogen and placed in an oven at 40° C. for the required amount of time (1 day, 1 month and 3 months). After the allotted time, the colour value was measured using a LOVIBOND™ PFXi-195 colourimeter.

The results are shown in Table 9.

TABLE 9

| | Colour Value | | |
|---|---|---|---|
| Example | Day 1 (APHA) | 1 Month (APHA) | 3 Months (Gardner) |
| 8 (Comp) | 345 | 356 | 2.7 |
| 9 | 423 | 348 | 1.0 |
| 10 | 442 | 305 | 0.1 |
| 11 (Comp) | 456 | 497 | 3.1 |

From the results it can be seen that the stabilising compositions according to the present invention (examples 9 and 10) have better colour stability compared to stabilising compositions which do not include the phosphite secondary antioxidant. Example 10 highlights the synergistic effect of the combination of LOWINOX™ AH25 with LOWINOX™ TBM-6 and the phosphite antioxidant as discolouration is further reduced.

1. A stabilising composition for a polyol and/or a polyurethane, comprising:
i. a first derivatised phenolic antioxidant having a molecular weight of at least about 400 g/mol and a melting point of less than about 100° C.;
ii. a second derivatised phenolic antioxidant having lower steric hindrance than the first derivatised phenolic antioxidant, which is a solid at ambient conditions; and
iii. a secondary antioxidant comprising a phosphite and/or a thioester.

2. The stabilising composition according to claim 1 which is absent any diphenylamine and/or alkylated diphenylamine.

3. The stabilising composition according to claim 1, wherein the contribution to VOC of the first derivatised phenolic antioxidant is less than about 10 ppm and/or wherein the contribution to FOG of the first derivatised phenolic antioxidant is less than about 100 ppm.

4. The stabilising composition according to claim 1, wherein the first derivatised phenolic antioxidant comprises one or more derivatised phenolic antioxidants of formula (I): 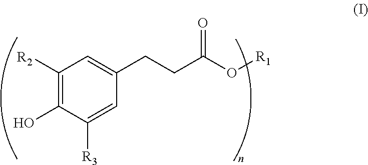
wherein n is 1 or 2;
wherein R₁ is a linear or branched alkyl group having from 1 to 30 carbons, optionally substituted with one or more ether groups; and
wherein R₂ and R₃ are each independently selected from straight or branched chain alkyl groups having from 1 to 5 carbon atoms.

5. The stabilising composition according to claim 4, wherein both R₂ and R₃ are t-butyl groups.

6. The stabilising composition according to claim 1, wherein the first derivatised phenolic antioxidant comprises 3,5-bis(1,1-dimethylethyl)-4-hydroxy-benzenepropanoic acid, C13-15 alkyl esters; a blend of 3,5-bis(1,1-dimethylethyl)-4-hydroxy-benzenepropanoic acid, C13-15 alkyl esters and tetrakismethylene (3,5-di-t-butyl-4-hydroxyhydrocinnamate) methane; octadecyl-3-(3′,5′-di-t-butyl-4′-hydroxyphenyl) propionate; and/or a blend of octadecyl-3-(3′,5′-di-t-butyl-4′-hydroxyphenyl) propionate and tetrakismethylene (3,5-di-t-butyl-4-hydroxyhydrocinnamate) methane.

7. The stabilising composition according to claim 1, wherein the first derivatised phenolic antioxidant is present in the stabilising composition in an amount of from about 30 wt. % to about 95 wt. %.

8. The stabilising composition according to claim 1, wherein the second derivatised phenolic antioxidant has a lower molecular weight than the first derivatised phenolic antioxidant.

9. The stabilising composition according to claim 1, wherein the second derivatised phenolic antioxidant has a molecular weight of lower than about 400 g/mol.

10. The stabilising composition according to claim 1, wherein the second derivatised phenolic antioxidant comprises:
i. a mono-hydroxybenzene; and/or
ii. a di-hydroxybenzene.

11. The stabilising composition according to claim 1, wherein the second derivatised phenolic antioxidant is present in the stabilising composition in an amount of from about 0.1 wt. % to about 50 wt. %.

12. The stabilising composition according to claim 1, wherein the phosphite comprises one or more alkyl phosphites.

13. The stabilising composition according to claim 1, wherein the secondary antioxidant is present in the stabilising composition in an amount of from about 0.01 wt. % to about 20 wt. %.

14. The stabilising composition according to claim 1 which has a melting point of less than about 100° C.

15. The stabilising composition according to claim 1, wherein the contribution to VOC of the stabilising composition is less than about 20 ppm.

16. The stabilising composition according to claim 1, wherein the contribution to FOG of the stabilising composition is less than about 200 ppm.

17. A stabilising composition for a polyol and/or a polyurethane, comprising:
a) a first derivatised phenolic antioxidant having a molecular weight of at least about 400 g/mol effective to provide a contribution to VOC of less than about 10 ppm and/or a contribution to FOG of less than about 100 ppm, and having a melting point of less than about 100° C.;
b) a second derivatised phenolic antioxidant having lower steric hindrance than the first derivatised phenolic antioxidant, which is a solid at ambient conditions; and
c) a secondary antioxidant comprising a phosphite and/or a thioester.

18. A stabilising composition for a polyol and/or a polyurethane, comprising:
a) a first derivatised phenolic antioxidant having a contribution to VOC of less than about 10 ppm and/or a contribution to FOG of less than about 100 ppm, and having a melting point of less than about 100° C.;
b) a second derivatised phenolic antioxidant having lower steric hindrance than the first derivatised phenolic antioxidant, which is a solid at ambient conditions; and
c) a secondary antioxidant comprising a phosphite and/or a thioester.

19. The stabilising composition according to claim 1, which when incorporated into a polyurethane foam causes the foam to undergo, on the application of a microwave scorch test, a colour change ΔE less than that of an equivalent foam into which an equivalent amount of industry-available stabilising composition (optionally any one of industry-available stabilising composition 1, 2, 3 or 4) has been incorporated.

20. The stabilising composition according to claim 1, which when incorporated into a polyurethane foam exhibits a contribution to VOC and/or FOG, as measured according to standard test method VDA 278, less than the contribution exhibited by an equivalent foam into which an equivalent amount of industry-available stabilising composition (optionally any one of industry-available stabilising composition 1, 2, 3 or 4) has been incorporated.

21. A fire retardant blend, comprising:
i. a stabilising composition according to claim 1; and
ii. a fire retardant.

22. (canceled)

23. A stabilised composition, comprising:
a polyol and/or a polyurethane; and
the stabilising composition according to claim 1.

24. The stabilised composition according to claim 23, wherein the polyurethane is a polyurethane foam.

25. (canceled)
